(19) United States
(12) Patent Application Publication
(10) Pub. No.: US 2009/0262543 A1
(43) Pub. Date: Oct. 22, 2009

(54) Light base structure of high-power LED street lamp

(75) Inventor: Yen-Wei Ho, Taichung (TW)

Correspondence Address: GENIUS ELECTRONIC OPTICAL CO., LTD., P.O. BOX 215, TAICHUNG, 40099, TW

(73) Assignee: GENIUS ELECTRONIC OPTICAL CO., LTD.

(21) Appl. No.: 12/230,637

(22) Filed: Sep. 3, 2008

(30) Foreign Application Priority Data
Apr. 18, 2008 (TW) 097206719

(51) Int. Cl. F21V 29/00; F21V 15/01

(52) U.S. Cl. 362/373; 362/362

(57) ABSTRACT

This invention is to propose a light base structure of high-power LED street lamp that has a concaved room with symmetrical rectangular plains inside. With the design, high-power LED modules can be mounted on the base and emit light with various interlacing included angles and at interlacing locations. The included angle of the normal lines of the outermost two symmetrical rectangular plains is designed between 60-140 degrees. The purpose of this invention is to produce optimal optical effects, including broadening lighted range and enhancing light brightness and uniformity in effective lighted area.

### FIELD ON THE INVENTION

### BACKGROUND OF THE INVENTION

In recent years, the brightness of LED has been advancing, greatly making its market application wider. Take prior art, for example, its features include: a light base that can mount multiple LED modules, and the base body convex out at same direction as the LED lights. At the convex side of the base facilitates multiple symmetrical mounting faces, the included angle of the first pair of symmetrical mounting faces (the pair closest to the central line of the base) is between 76˜86 degrees, the included angle of the second pair of symmetrical mounting faces (the pair secondly closest to the central line of the base) is between 49˜59 degrees, and the included angle of the third pair of symmetrical mounting faces (the pair 3rdly closest to the central line of the base) is between 37˜47 degrees. Although such structure makes lighted range bigger, its actual performance on lighting effects is still controversial This is because the included angle of the two outermost mounting faces is around 120 degrees, and also the included angles of adjacent pair of mounting faces are big. That would probably cause light uniformity problem. Regarding to another prior patent contains of a light base with a concaved room in one side, which can mount three rows of LED light sets with one row in the middle and two other rows mounted slanted on both sides. The design does make LED light interlace and make good lighting effects. However, the brightness is overly focused on the center zone out of entire lighted area due to overlapping emitting of the three rows of LED light, and too weak in outskirt lighted area (as indicated as the dot line in the figure), so it is flawed in the view of a “street lamp”.

To avoid the drawbacks of prior arts, the inventor underwent numerous researches and tests, and finally presents you this invention for patent application.

### BRIEF SUMMARY OF THE INVENTION

The purpose of this invention is to propose a light base structure for containing high-power LED modules and produce optimal optical effects, including broaden lighted range and enhancing brightness and uniformity in effective lighted area.

To reach the end, the invention proposes a light base structure of a high-power LED street lamp that contains: a concaved room (polygon-shaped in its sectional view) in one side of the base. Taking a central line for the concaved room, both sides apart from the central line have at least four rectangular plains. They are in parallel adjacent to one another in longitudinal direction, and U-curved formed in sectional view. The included angle of the normal lines of the two outermost rectangular plains is designed between 60 to 140 degrees as the optimal angle. Moreover, rectangular plains can be designed so that their normal lines can interlace to one another with different included angles and at different interlacing locations, making the LED modules light uniformly and efficiently.

### BRIEF DESCRIPTION OF THE DRAWINGS

FIG. 1—a perspective view of the preferred embodiment

FIG. 2—a bottom-side view of the preferred embodiment

FIG. 3—a sectional view and normal lines view of rectangular plains of the preferred embodiment

FIG. 4—a regional exploded view of the preferred embodiment

FIG. 5—a perspective view of the FIG. 4 after assembling LED modules

FIG. 6—a sectional view and LED lighting angle view of the FIG. 5

FIG. 7—an assembly explanative view of transparent cover

FIG. 8—an assembled view of FIG. 7

FIG. 9—a perspective view of radiator module of the preferred embodiment

FIG. 10—a sectional view of FIG. 7

FIG. 11—an explanative view of equivalent techniques I of the concaved room of the preferred embodiment

FIG. 12—an explanative view of equivalent techniques II of the concaved room of the preferred embodiment

FIG. 13—an explanative view of equivalent techniques III of the concaved room of the preferred embodiment

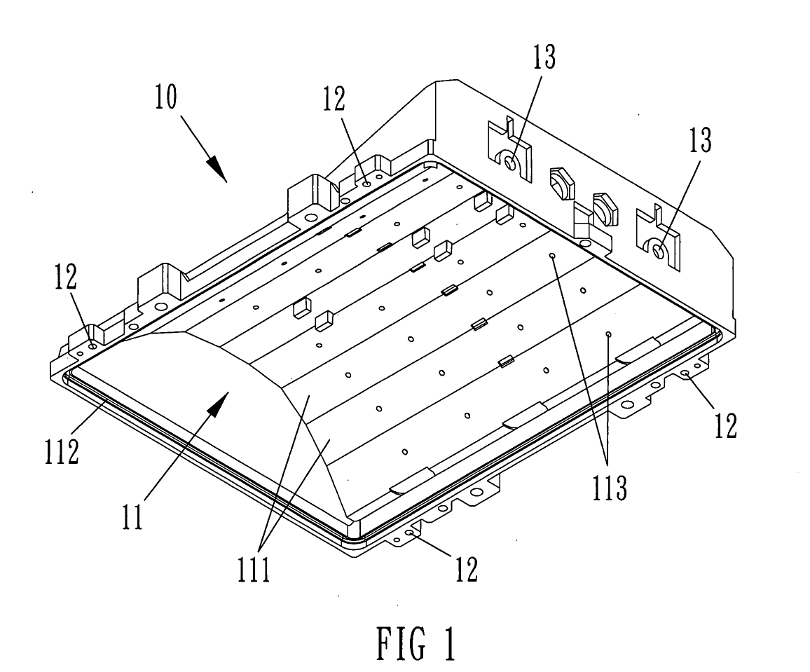

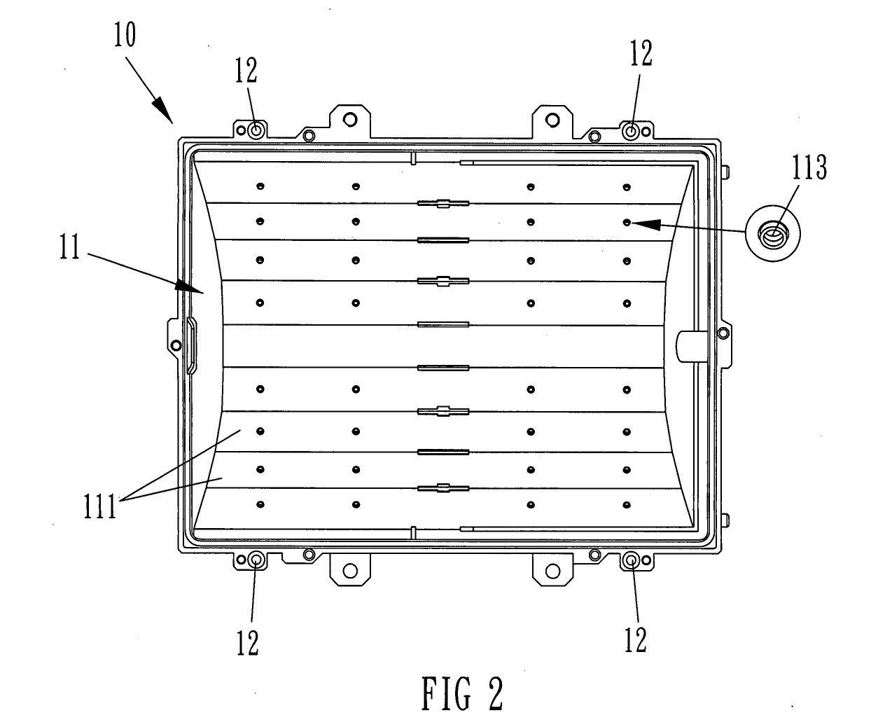

### DETAILED DESCRIPTION OF THE INVENTION

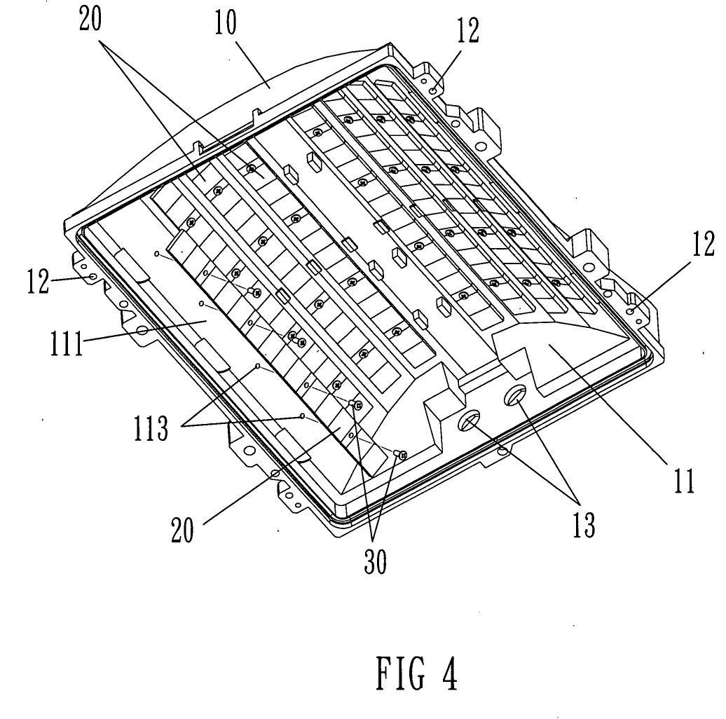

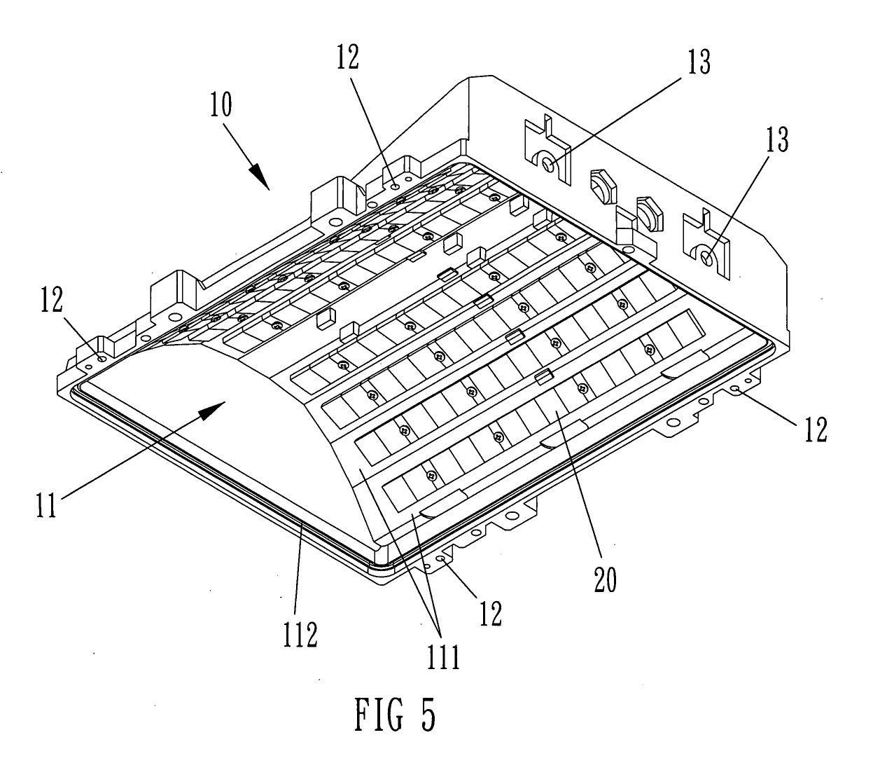

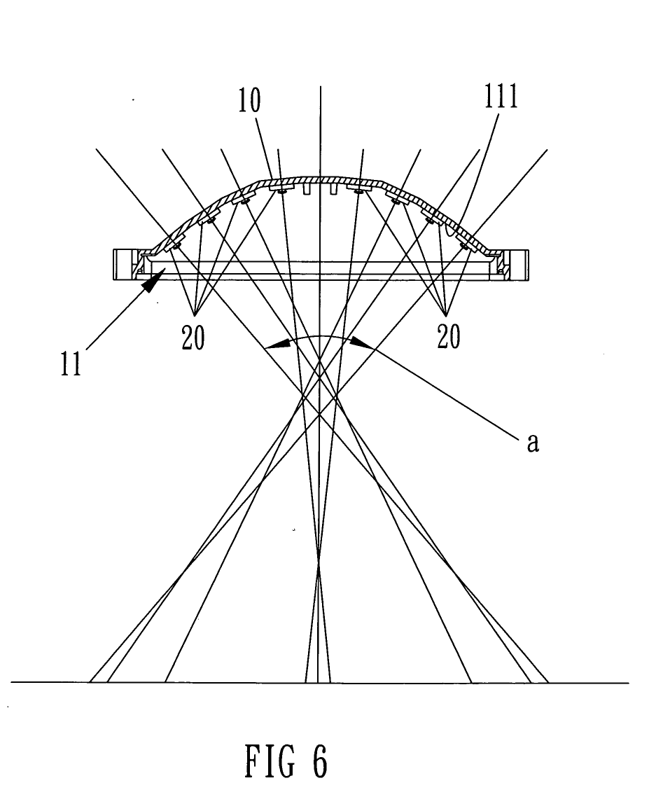

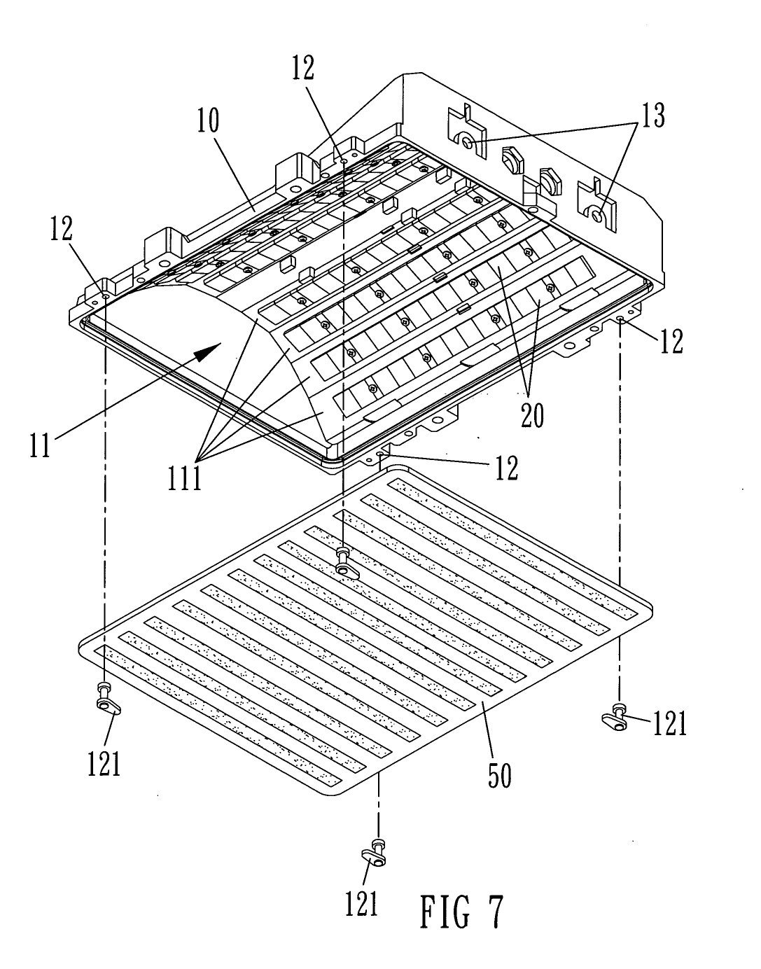

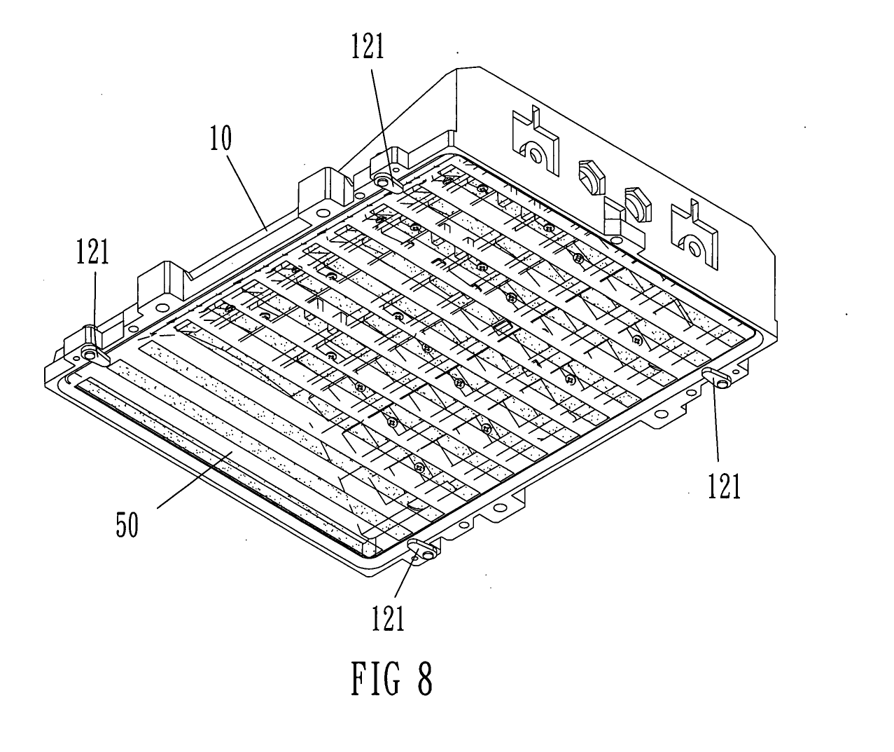

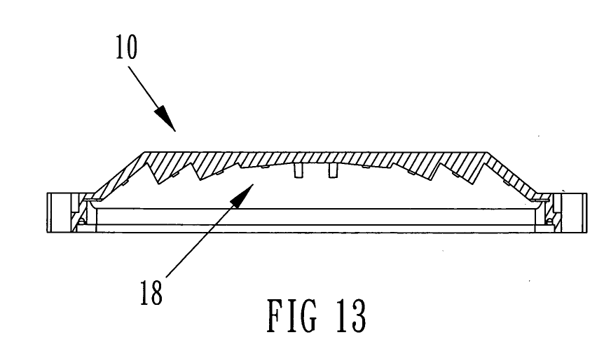

First, with references to FIG. 13, the light base 10 of the invention has a concaved room 11 in one side, which is used to contain multiple LED modules 20 (as shown in FIG. 4˜6). Along the central line of the concaved room 11, each side has at least four rectangular plains 111. Rectangular plains 111 are in parallel adjacent to one another in its longitudinal direction, and they are U-curved formed in sectional view. At the rim of the concaved room 11 is circled by a rim groove 112 used to fit with a rubber gasket (not shown in the figures), so that a transparent cover 50 (as shown in FIG. 7 and 8) can fit tightly onto the rim groove 112 to completely seal the concaved room 11, and thus no rain or any insect can enter into the concaved room 11 to interfere with LED performances; also shown in FIG. 7 and 8, at outer wall of the light base 10 sets symmetrical fixing holes 12 so that L-shaped bolts 121 can rotate against them to lock and position the transparent cover 50 firmly onto the light base 10; And on another side of outer wall (adjacent to the one with fixing holes 12) sets at least one hole 13 for power cable (not shown in figures) to go through.

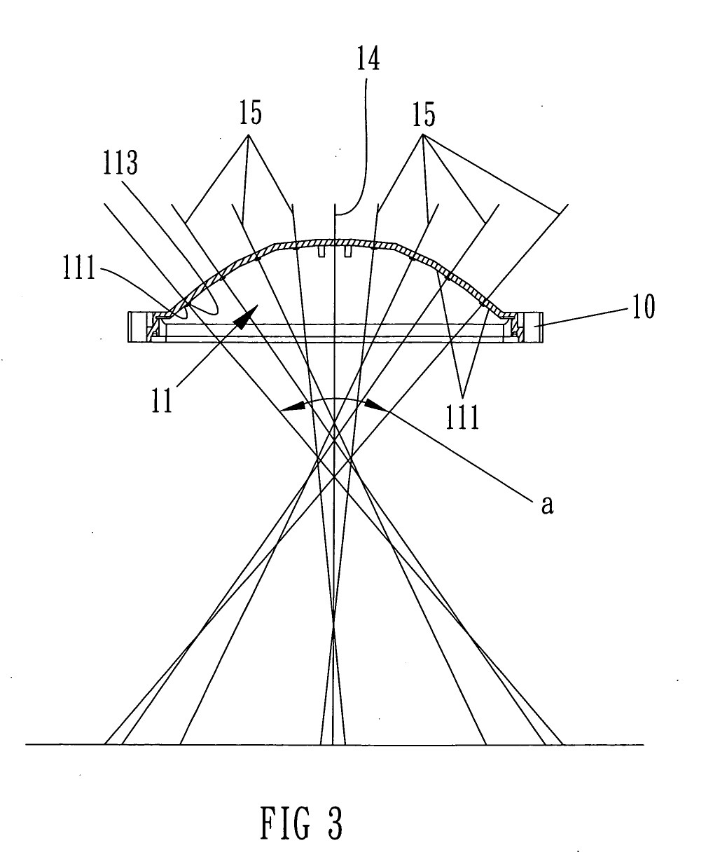

After mounting the high-power LED modules 20 on the light base 10, the LED modules 20 can, by means of well-designed multiple rectangular plains 111, emit light interlacedly (as shown in FIG. 3) so that the light can be spread in a big range and uniformly with increased brightness.

Moreover, there are screw holes 113 on the rectangular plains 111 at proper positions for, cooperating with screws 30, mounting the high-power LED modules 20. The LED modules 20 can be string-type, brick-type or any equivalent ones. The LED module 20 exemplified in this embodiment contains of metal or ceramic plate with high heat-conducting coefficient. Aforementioned metal plate can be aluminum rod or plate, and multiple LED are electrically connected in series, thus making LED modules 20 can be easily mounted onto the rectangular plains 111.

Further on the special design of rectangular plains 111 (referring to the FIG. 3), the included angle(a) of the normal lines of the two outermost rectangular plains 111 is designed between 60 to 140 degrees as the optimal angle. For descriptive purpose, the embodiment sets the angle(a) close to 80 degrees to obtain the widest and the most effective lighted range after the high-power LED modules 20 being mounted on the rectangular plains 111.

Furthermore on explanations (referring to the FIG. 3), rectangular plains 111 can be designed so that their normal lines 15 can interlace to one another with different included angles and at different interlacing locations, making the LED modules 20 light uniformly and efficiently.

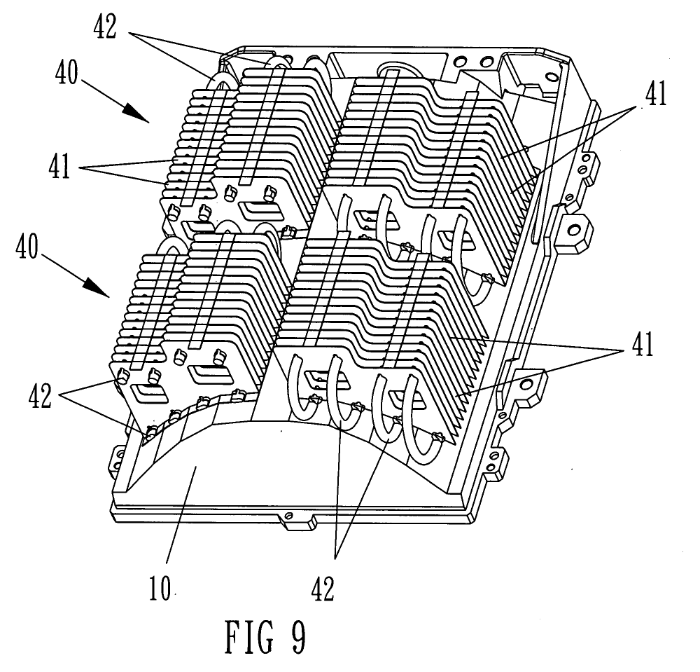

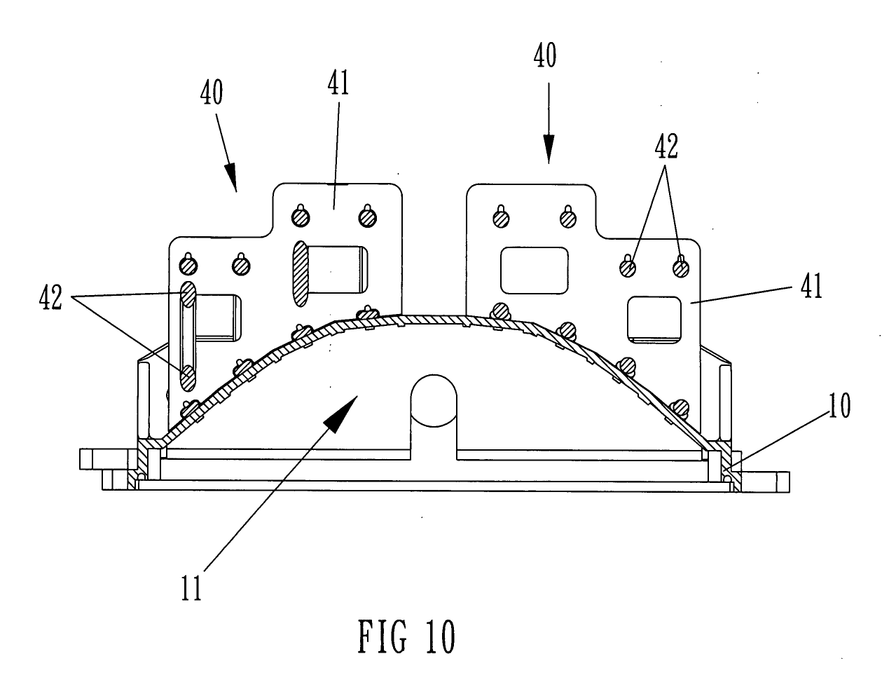

On the other hand, please refer to the FIG. 9 and 10 for descriptions of radiator module 40 set outer part of light base 10 for transferring the enormous heats released from high-power LED module 20. The radiator module 40 is composed of multiple equally spaced radiator fins 41 that are connected in series by heat-conducting tube 42. For better mounting effects, the embodiment welds the radiator module 40 onto the light base 10 directly. Of course, however, they can be mounted by other means such as screwing and bolts, thus any means of mounting shall be still regarded as equivalent techniques of the invention.

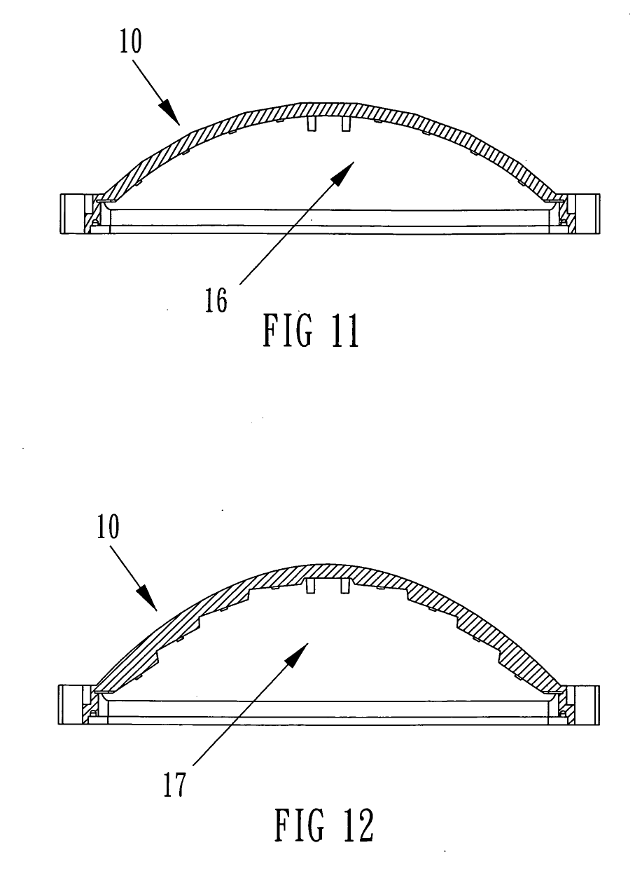

With references to the FIG. 11-13, the concaved room of light base 10 can be a curved concaved room 16, stair-like concaved room 17, or V-grooved concaved room 18 for reaching the purpose of uniform, bright and broad-range lighting.

With all aforementioned, the invention deserves grant of a patent based on its capability of industrial application and absolute novelty. The example illustrated above is just an exemplary embodiment for the invention, and shall not be utilized to confine the scope of the patent. Any equivalent modifications within the scope of claims of the patent shall be covered in the protection for this patent.

What is claimed is:

1. A light base structure of a high-power LED street lamp that contains of a concaved room, with being polygon-shaped in its sectional view, in one side of the base;
wherein both sides apart from the central line of the said concaved room have at least four rectangular plains that are in parallel adjacent to one another, and U-curved formed in sectional view;
wherein the included angle of the normal lines of the two outermost said rectangular plains is designed between 60 to 140 degrees as the optimal angle, and normal lines of the said rectangular plains interlace to one another with different included angles and at different interlacing locations.

2. The light base structure of a high-power LED street lamp in claim 1, wherein at the rim of the said concaved room is circled by a rim groove used to fit with a rubber gasket so that it can be sealed tightly by a transparent cover.

3. The light base structure of a high-power LED street lamp in claim 1, wherein at outer wall of the said light base sets symmetrical fixing holes with rotatable L-shaped bolts inside, and the said rotatable L-shaped bolts rotate against the said fixing holes to lock and position the said transparent cover firmly onto the said light base.

4. The light base structure of a high-power LED street lamp in claim 1, wherein outer wall of the said light base has at least one hole for power cable to go through.

5. The light base structure of a high-power LED street lamp in claim 1, wherein there are properly spaced screw holes on the said rectangular plains for, with cooperating with screws, mounting high-power LED modules.

6. The light base structure of a high-power LED street lamp in claim 1, wherein there is at least one radiator module set at outer part of the said light base.

7. The light base structure of a high-power LED street lamp in claim 6, wherein the said radiator module contains of multiple equally spaced radiator fins that are connected in series by multiple heat-conducting tubes.

8. The light base structure of a high-power LED street lamp in claim 6, wherein the said radiator module is welded onto the outer part of the said light base.

9. A light base structure of a high-power LED street lamp that contains of a concaved room, with polygon-shaped in its sectional view, in one side of the base;
wherein both sides apart from the central line of the said concaved room have at least four rectangular plains that are in parallel adjacent to one another;
wherein there is at least one radiator module set at outer part of the said light base.

10. The light base structure of a high-power LED street lamp in claim 9, wherein the included angle of the normal lines of the two outermost said rectangular plains is designed between 60 to 140 degrees.

11. The light base structure of a high-power LED street lamp in claim 9, wherein the said radiator module contains of multiple equally spaced radiator fins that are connected in series by multiple heat-conducting tubes.

12. The light base structure of a high-power LED street lamp in claim 9, wherein the said radiator module is welded onto the outer part of the said light base.

13. The light base structure of a high-power LED street lamp in claim 1 or 9, wherein the said polygon-shaped concaved room can be replaced by a curved concaved room.

14. The light base structure of a high-power LED street lamp in claim 1 or 9, wherein the said polygon-shaped concaved room can be replaced by a stair-like concaved room.

15. The light base structure of a high-power LED street lamp in claim 1 or 9, wherein the said polygon-shaped concaved room can be replaced by a V-grooved concaved room.
